(19) United States
(12) Patent Application Publication
(10) Pub. No.: US 2025/0306569 A1
(43) Pub. Date: Oct. 2, 2025

(54) METHOD FOR ERROR-MINIMIZED STACK CONTACTING

(71) Applicant: HARTING Customised Solutions GmbH & Co. KG, Espelkamp (DE)

(72) Inventors: Rudolf NIENABER, Bielefeld (DE); Guido STEENBOCK, Börnsen (DE); Oliver UNGRUH, Amtzell (DE)

(21) Appl. No.: 19/088,800

(22) Filed: Mar. 24, 2025

(30) Foreign Application Priority Data
Mar. 26, 2024 (DE) 10 2024 108 576.2

(51) Int. Cl. G05B 19/4155

(52) U.S. Cl. CPC G05B 19/4155; G05B 2219/45224

(57) ABSTRACT

The disclosure relates to a method for error-minimized electrolysis stack contacting. The method includes: providing at least one electrolysis stack having at least two conductive, spaced-apart plates; providing an assembly device having at least one mount for at least two cores, wherein each core has a plug end and a connection end; providing a control device for automatic detection and/or for electrical testing; providing a contacting unit having at least one plug-in unit, wherein the plug-in unit is electrically connectable to the at least two plug ends of the at least two cores; providing at least one coding on the at least one plug-in unit and/or the respective plug end and/or the respective connection end and/or on the respective core of the at least two cores; carrying out an automatic acceptance test, wherein the position of the connection ends is controlled on the basis of the coding; evaluating the result; and transmitting the acceptance test result to a piece of data processing equipment and carrying out a predetermined acceptance test action.

### BACKGROUND

### Technical Field

The present disclosure relates to a method for error-minimized electrolysis stack contacting. In particular, the method is intended to enable the extension of a statistical process control (SPC) method to the stack, including cell voltage monitoring (CVM).

### Description of the Related Art

The assembly of electrolysis stacks is a complex process that requires high precision and care. Each stack consists of several components which must be mounted in a specific order and orientation to ensure efficient and safe operation. Errors during the assembly process can lead to a variety of problems, including inefficient electrolysis, increased energy consumption, and potential component damage.

In addition, the assembly of electrolysis stacks is often a time-consuming and labor-intensive process. Each stack must be carefully inspected and checked to ensure that all components are correctly assembled and functional. This requires specialized personnel and can lead to production delays. Therefore, Applicant believes there is a need for improved techniques and devices for assembling electrolysis stacks that make the process more efficient and accurate and minimize the risk of errors.

### BRIEF SUMMARY

Embodiments of the present disclosure improve the efficiency and accuracy of electrolysis stack contacting in the assembly process. In addition, the costs of quality assurance in series production is significantly reduced through the application of the SPC method.

The disclosure relates to a method for error-minimized electrolysis stack contacting, wherein the method comprises the following method steps. Providing at least one electrolysis stack, wherein the electrolysis stack comprises at least two conductive, spaced-apart plates.

Wherein each of the at least two conductive plates can comprise at least one contacting facility.

According to the Poka-Yoke principle, a further configuration can provide a staggered arrangement of the contacting facilities of two consecutive plates. In an exemplary configuration with four plates, the contacting facility of the first plate and the contacting facility of the third plate can be aligned. The contacting facility of the second plate and the contacting facility of the fourth plate can be aligned.

Poka-Yoke is a Japanese term meaning “to avoid errors.” It is a concept from quality management and lean production that aims to prevent errors in production processes through preventive measures.

With regard to staggered contacting facilities, Poka-Yoke can be utilized to configure and arrange the contacts so that they can only be contacted in a specific way, or, in other words, incorrect contacting is made much more difficult. This can be achieved by different shapes and/or sizes and/or positions of the respective contacting facility. This prevents cores to be contacted from being incorrectly connected, which could lead to errors, damage, or long rework times.

A further method step is providing an assembly device, wherein the assembly device comprises at least one mount for at least two cores, wherein each core has a plug end and a connection end.

The term “core” refers to a single conductor. These cores are typically made of a conductive material such as copper or aluminum and may be insulated to safely conduct an electrical current from one point to another. In a multi-core cable, several cores may be grouped together to allow for multiple circuits or phases. The cores may also be installed individually.

The connection end can be provided with a cable lug, a core end ferrule or an alligator clip.

A further method step is providing a control device, wherein the control device comprises at least one first device for automatic detection, in particular for optical detection, and/or one second device for electrical testing.

An optical detection system is a technological system that can use optical data to identify and interpret specific coded information. This system may comprise machine learning and/or artificial intelligence algorithms to detect patterns in the visual data and link these patterns to specific coded information. The system may comprise at least one camera or other system for capturing optical or visual information. In the case of Poke-Yoke with a staggered arrangement of contacting facilities, a second camera may be utilized to control the contacting facilities which are arranged one below the other.

A further method step is providing a contacting unit, wherein the contacting unit comprises at least one plug-in unit, wherein the plug-in unit is electrically connectable to the at least two plug ends of the at least two cores.

The plug-in unit can be designed as a plug or as an I/O box. An I/O box (input/output box) is an instrument that can be used to collect signals from cables, sensors, and actuators and send them to a control unit (input), and conversely, to send signals from the control unit to the sensors and actuators (output). To carry out a pre-test action and/or acceptance test action, a test plug can be attached to the contacting unit, or the connection ends of the cores can be tapped using test probes or test terminals. The test plug can be connected to the control device wirelessly or via a cable connection.

A further method step is providing at least one coding on the at least one plug-in unit and/or the respective plug end and/or the respective connection end and/or on the respective core of the at least two cores.

Various coding options can be utilized. The individual options can also be combined. Color coding uses different colors to identify different types of cores or cables having different functions. This is a very simple and visually easily detectable technique. Advantageously, the cores may be provided with a ring coding that surrounds the core at at least one point larger than three-quarters of its circumference.

With numeric coding or alphanumeric coding, each core can be assigned a unique sequence of numbers or letters, or a combination thereof. This coding can be printed on the core or attached as a label.

Barcodes as coding allow a large amount of information to be stored in a small space. These barcodes can be read quickly and easily with a scanner. They can be used to store detailed information about the core.

A further method step is carrying out automatic, in particular optical, acceptance testing, wherein the position of the connection ends is controlled on the basis of the coding. Alternatively or in addition to optical acceptance testing, an electrical acceptance test can be carried out by the control device, wherein electrical continuity from one plug end to the corresponding connection end is tested.

A further method step is evaluating the result of the optical acceptance test by at least one evaluation unit which is designed to carry out a pre-test action and/or the acceptance test action.

A further method step is transmitting the acceptance test result of the automatic, in particular the optical, acceptance test and carrying out a predetermined acceptance test action.

A continuity test can be considered successful if the measured resistance value is very low. Typically, this is the case when the electrical resistance is close to zero ohms. For example, this would be 0.1 ohms. However, the exact threshold for a successful check can vary depending on the specific requirements of the system to be tested. This indicates that a functioning electrical path or continuity exists between a plug end and the corresponding connection end being tested. Continuity testing can also be carried out between a connection end and a contact of a plug connected to the respective core. The plug unit can also be used to output a signal to a core or detect the signal being input via a core.

A further method step is carrying out a pre-test for automatic, in particular optical, pre-testing, wherein the position of the connection ends within the assembly device is controlled on the basis of the coding. Alternatively or additionally, the correct fit of a cable lug, a core end ferrule or an alligator clip with which at least one connection end is provided can be tested, in particular on a plug-in board and/or on an electrolysis stack. In doing so, it can be tested to see whether a plug-in sleeve is only half plugged onto a contact, which would result in poor contact. The plug-in board can be used with a pre-assembled cable harness, so that during final assembly only cables need to be replugged in a predefined order.

The optical detection device can test in this case whether a core or at least two cores are arranged in the correct position of the at least one electrolysis stack or are in contact with it.

A further method step is evaluating the result of the optical pre-test or acceptance test and the electrical pre-test by at least one evaluation unit which is designed to carry out a pre-test action and/or the acceptance test.

A further method step is transmitting the pre-test result of the automatic, in particular the optical pre-test and/or the electrical pre-test to the piece of data processing equipment and carrying out a predetermined pre-test action.

The piece of data processing equipment can be designed as a PC, measuring computer or in the cloud.

In one configuration, the evaluation unit or control device, in particular the first device for automatic detection, in particular for optical detection, can comprise an AI module for image or image data analysis. The evaluation unit and the control device can be configured as a single piece. The first device can be wired or connected wirelessly to the control device.

The AI module comprises at least one input node and at least one output node. The input node and the output node in an AI module for image analysis in stack control can refer to the points at which data flows into or out of the model.

In this case, the input node of the AI module can receive the image data (or other relevant data) from the first device, in particular, which is used to analyze the stack control. This data could, for example, come from the camera and/or other sensors monitoring the assembly process.

The AI module's output node can output the analysis results. These results could include, for example, information about whether the stack was assembled correctly, whether there are any signs of potential defects, or other relevant information obtained from the analysis of the image data.

A training dataset for the AI module can be obtained from an analysis of defective or faulty stacks. The training dataset can further comprise labels for training the AI module to optically detect stack errors.

The individual method steps can be performed serially. In an advantageous embodiment, the method steps can be performed in the order explained above.

In an advantageous configuration, the following further method steps can be carried out, namely carrying out a first electrical pre-test by the control device, wherein an electrical continuity from a plug end to the associated connection end of the at least two cores is tested.

A further method step is carrying out a pre-test for automatic, in particular optical pre-testing, wherein the position of the plug connection within the assembly device is controlled on the basis of the coding.

A further method step is transmitting the pre-test result of the automatic, in particular the optical pre-test and/or the electrical pre-test to the piece of data processing equipment and carrying out a predetermined pre-test action.

The pre-test action may comprise displaying and documenting the pre-test result. It can also include releasing the tested assembly if the pre-test is passed or blocking the assembly if the pre-test failed.

The pre-test refers to a test that can be carried out after completion of the assembly or before the delivery of an assembly such as a cabling unit.

In an advantageous configuration, the following further method steps can be carried out, namely coding the at least two cores, wherein the coding has at least one of the following means or devices: a circumferential ring coding and/or a color-coded element and/or an optical code and/or a barcode and/or a quick response code and/or an electronic code, in particular a radio-frequency identification element, and/or a near field communication element.

In a further advantageous configuration, the following further method steps can be carried out, namely coding at least two cores, wherein two cores of the at least two cores form a core pair, wherein each core of the core pair is coded differently from one another, or coding the at least two cores, wherein the at least two cores form a core assembly, wherein each core of the core assembly is coded differently from one another.

In a further advantageous configuration, the following further method steps can be carried out, namely coding at least two cores, wherein the coding is provided in such a way that adjacent cores of a respective core pair or core assembly are coded differently.

The core pair is formed by two cores, with the pairing being floating. This means that an alternating coding results, for example, red, blue, red, with adjacent cores being coded differently. A core assembly may contain more than two cores, with each core possibly being coded differently, although patterns can also be provided.

In a further advantageous configuration, the following further method steps can be carried out, namely carrying out electrical testing during the acceptance test and/or pre-test, wherein it is tested that a plug end of a core is only electrically connected to the respective associated connection end of the same core.

In a further advantageous configuration, the following further method steps can be carried out, namely carrying out at least one of the actions pre-test action or final test action, wherein transmitting at least one data set to the piece of data processing equipment and/or the database connection is included and/or the documentation of the final test result and/or the pre-test result is included.

In a further advantageous configuration, the following further method steps can be carried out, namely transmitting the test result to a data processing device, wherein the data processing device is formed in the cloud and/or the control device is connected to a master computer.

The disclosure also relates to a method for carrying out a pre-test action. The pre-test action can be carried out at a location different from the location of the acceptance test. This allows for carrying out pre-assembly of an electrolysis stack. This can save time during final assembly or acceptance testing.

In particular, the method should enable the extension of a statistical process control (SPC) method to the stack including cell voltage monitoring (CVM).

A method for error-minimized electrolysis stack contacting may be provided according to at least one of the preceding advantageous configurations. In particular, the method can be utilized to carry out pre-testing.

The method comprises providing an assembly device, wherein the assembly device comprises at least one mount for at least two cores, wherein each core has a plug end and a connection end.

In a further method step, a control device is provided, wherein the control device comprises at least one first device for automatic detection, in particular for optical detection, and a second device for electrical testing.

In a further method step, providing a contacting unit is carried out, wherein the contacting unit comprises at least one plug-in unit, wherein the plug-in unit is electrically connectable to the at least two plug ends of the at least two cores.

In a further method step, providing at least one coding is carried out on the at least one plug-in unit and/or the respective plug end and/or the respective connection end and/or on the respective core of the at least two cores.

In a further method step, a first electrical pre-test is carried out by the control device, wherein an electrical continuity from one plug end to the associated connection end of the at least two cores is tested.

In a further method step, a pre-test is carried out for automatic, in particular optical, pre-testing, wherein the position of the connection end within the assembly device is controlled on the basis of the coding.

In a further method step, evaluating the result of the optical pre-test and the electrical pre-test is taking place by at least one evaluation unit which is designed to carry out the pre-test action and/or an acceptance test action.

In a further method step, transmitting the pre-test result of the automatic, in particular the optical pre-test and/or the electrical pre-test to a piece of data processing equipment and carrying out a predetermined pre-test action are taking place.

In a further advantageous configuration, providing at least one plug-in board can be carried out for electrical testing, wherein the plug-in board comprises at least two connections for plugging in or contacting the connection ends. The plug-in board can also be designed to carry out electrical testing.

The disclosure also relates to a device for error-minimized stack contacting, comprising an assembly device, wherein the assembly device comprises a mount for at least two cores. The device further comprises a control device, wherein the control device comprises at least one first device for automatic detection, in particular for optical detection, and a second device for electrical testing. The device comprises at least one contacting device, wherein the contacting unit comprises at least one plug-in unit, wherein the plug-in unit is electrically connectable to at least two plug ends of the at least two cores, and at least one evaluation unit which is designed to carry out the pre-test action and/or acceptance test action. The device comprises a piece of data processing equipment and/or a database connection, and a piece of communication equipment which is designed to establish communication with the piece of data processing equipment and/or the database connection. The database connection can be designed as a wired data connection and/or as a wireless data connection.

The contacting unit can comprise a plug-in unit, the plug-in unit can be designed in two parts, so that during assembly, the at least two plug ends of the at least two cores are electrically connected and the plug-in unit is subsequently inserted into a frame already present in a control cabinet. This allows for preconfiguration of the cabling.

In a further embodiment of the device, the piece of data processing equipment is part of the device and/or arranged spaced apart from the device, wherein the device is particularly formed in a cloud and/or the control device is connected to a master computer. The data connection can be designed as a wired data connection and/or as a wireless data connection.

In another embodiment, the plug ends leading to the electrolysis stack can be combined in a connector that accommodates the plug ends. The electrolysis stack provides a suitable socket for this purpose. This allows the electrolysis stacks to be connected more quickly and securely.

For this purpose, the plug ends can be connected to contact elements. These may be fixed, i.e., non-spring-loaded, contact elements.

The device described above may be designed to carry out the methods described above.

All definitions and explanations mentioned above apply to all exemplary embodiments. The disclosure is not limited to the described embodiments. Within the scope of the disclosure, all described and/or illustrated features can be combined as desired, unless otherwise stated.

### BRIEF DESCRIPTION OF THE SEVERAL VIEWS OF THE DRAWINGS

FIG. 1 shows a device for error-minimized stack contacting; and

FIG. 2 shows a device for error-minimized stack contacting; and

FIG. 3 shows a device for error-minimized stack contacting; and

FIG. 4 shows a method for error-minimized stack contacting.

### DETAILED DESCRIPTION

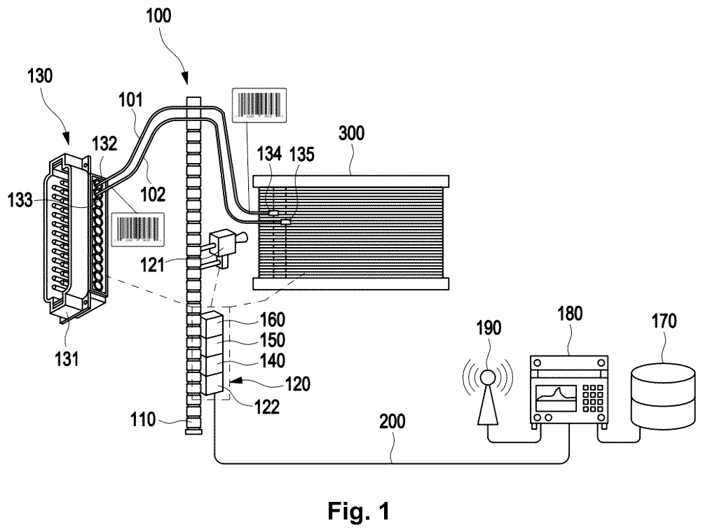

FIG. 1 shows a device for error-minimized stack contacting, comprising an assembly device 100 for an electrolysis stack 300, wherein assembly device 100 comprises a mount 110 for at least two cores 101, 102. A control device 120, wherein control device 120 comprises at least one device 121 for automatic detection, in particular for optical detection, and a second device 122 for electrical testing. A contacting unit 130, wherein contacting unit 130 comprises at least one first plug-in unit 131, wherein the plug-in unit is electrically connectable to at least two plug ends 132, 133 of at least two cores 101, 102. Contacting unit 130 is designed as a plug. An evaluation unit 140 which is designed to carry out the pre-test action and/or acceptance test action. A piece of data processing equipment 150 and/or a database connection. A piece of communication equipment 160, which is designed to establish a wired data connection 200 or wireless data connection 190 to the piece of data processing equipment 150 and/or the database connection to the database or cloud 170, which is designed as a data connection 190, 200. The evaluation of data can also be carried out in a master computer 180. To carry out the pre-test action and/or acceptance test action, a test plug can be attached to the contacting unit (130) or the connection ends (134, 135) can be tapped via test probes or test terminals.

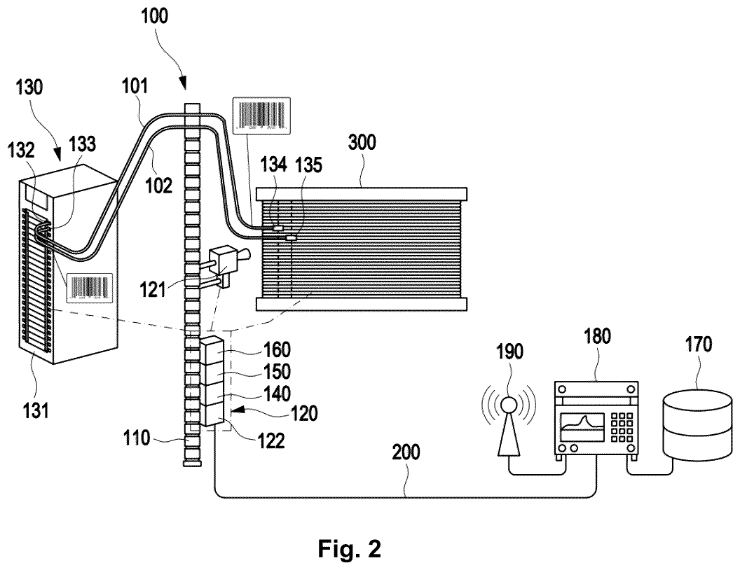

FIG. 2 shows a device for error-minimized stack contacting, comprising an assembly device 100 for an electrolysis stack 300, wherein assembly device 100 comprises a mount 110 for at least two cores 101, 102. A control device 120, wherein control device 120 comprises at least one device 121 for automatic detection, in particular for optical detection, and a second device 122 for electrical testing. A contacting unit 130, wherein contacting unit 130 comprises at least one first plug-in unit 131, wherein the plug-in unit is electrically connectable to at least two plug ends 132, 133 of at least two cores 101, 102. Contacting unit 130 is designed as an I/O box. An I/O box (input/output box) is a device which is designed to collect signals from cables, sensors, and actuators and send them to a control unit (input), and conversely, to send signals from the control unit to the sensors and actuators (output). An evaluation unit 140 which is designed to carry out the pre-test action and/or acceptance test action. A piece of data processing equipment 150 and/or a database connection. A piece of communication equipment 160 which is designed to establish communication with the piece of data processing equipment and/or the database connection.

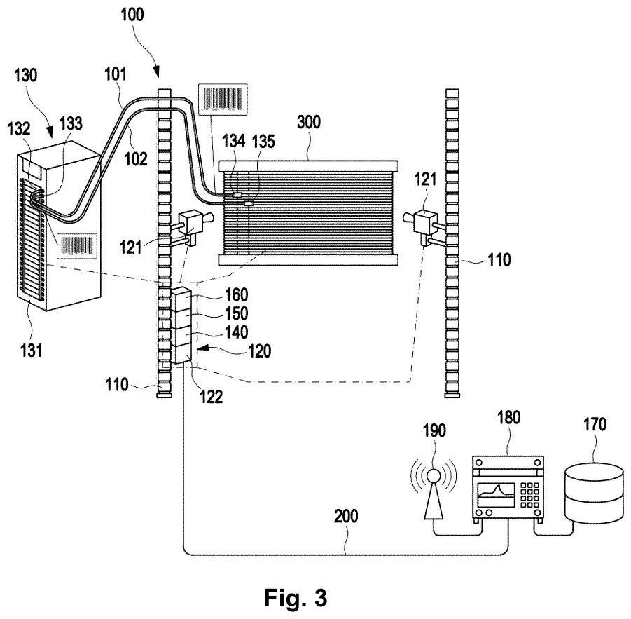

FIG. 3 shows a device for error-minimized stack contacting, comprising an assembly device 100 for an electrolysis stack 300, wherein the assembly device 100 comprises a mount 110 for at least two cores 101, 102. A control device 120, wherein control device 120 comprises two devices 121 for automatic detection, in particular for optical detection, and a second device 122 for electrical testing. A contacting unit 130, wherein contacting unit 130 comprises at least one first plug-in unit 131, wherein the plug-in unit is electrically connectable to at least two plug ends 132, 133 of at least two cores 101, 102. Contacting unit 130 is designed as an I/O box. An I/O box (input/output box) is a device designed to collect signals from cables, sensors, and actuators and send them to a control unit (input), and conversely, to send signals from the control unit to the sensors and actuators (output). An evaluation unit 140 which is designed to carry out the pre-test action and/or acceptance test action. A piece of data processing equipment 150 and/or a database connection. A piece of communication equipment 160 which is designed to establish communication with the piece of data processing equipment and/or the database connection.

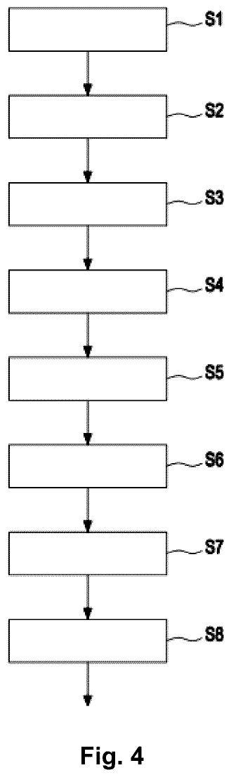

FIG. 4 shows a method for error-minimized stack contacting. The method comprises, in a first method step S1, providing at least one electrolysis stack, wherein the electrolysis stack comprises at least two conductive, spaced-apart plates.

In a second method step S2, providing an assembly device, wherein the assembly device comprises at least one mount for at least two cores, wherein each core has a plug end and a connection end. Providing an assembly device, wherein the assembly device comprises at least one mount for at least two cores, wherein each core has a plug end and a connection end.

In a third method step S3, providing a control device, wherein the control device comprises at least one first device for automatic detection, in particular for optical detection, and a second device for electrical testing.

In a fourth method step S4, providing a contacting unit, wherein the contacting unit comprises at least one plug-in unit, wherein the plug-in unit is electrically connectable to the at least two plug ends of the at least two cores.

In a fifth method step S5, providing at least one coding on the at least one contacting unit and/or the respective plug end and/or the respective connection end and/or on the respective core of the at least two cores. The contacting unit can comprise a plug-in unit. The plug-in unit can be designed as a plug or as an I/O box.

In a sixth method step S6, carrying out automatic, in particular optical, acceptance testing, wherein the position of the plug connection is controlled on the basis of the coding.

In a seventh method step S7, evaluating the result of the optical acceptance test and the electrical acceptance test by at least one evaluation unit which is designed to carry out the pre-test action and/or acceptance test action.

In an eighth method step S8, transmitting an acceptance test result of the automatic, in particular optical, acceptance test to a piece of data processing equipment and carrying out a predetermined acceptance test action.

German patent application no. 10 2024 108 576.2 filed, filed Mar. 26, 2024, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for error-minimized electrolysis stack contacting, comprising:
providing at least one electrolysis stack, wherein the electrolysis stack comprises at least two conductive, spaced-apart plates;
providing an assembly device, wherein the assembly device comprises at least one mount for at least two cores, wherein each core has a plug end and a connection end;
providing a control device, wherein the control device comprises at least one first device for automatic detection and/or one second device for electrical testing;
providing a contacting unit, wherein the contacting unit comprises at least one plug-in unit, wherein the plug-in unit is electrically connectable to the at least two plug ends of the at least two cores;
providing at least one coding on the at least one plug-in unit and/or the respective plug end and/or the respective connection end and/or on the respective core of the at least two cores;
carrying out an automatic acceptance test, wherein the position of the connection ends is controlled on the basis of the coding;
evaluating the result of the optical acceptance test by at least one evaluation unit which is designed to carry out the acceptance test and/or a pre-test; and
transmitting the acceptance test result of the automatic acceptance test to a piece of data processing equipment and carrying out a predetermined acceptance test action.

2. The method according to claim 1, further comprising:
coding the at least two cores, wherein the coding has at least one of the following devices:
circumferential ring coding;
a color-coded element;
an optical code, wherein the code is a barcode or a quick response code; and
an electronic code, wherein the code is a radio-frequency identification element or a near field communication element.

3. The method according to claim 1, further comprising:
coding at least two cores, wherein two cores of the at least two cores form a core pair, wherein each core of the core pair is coded differently from one another, or coding the at least two cores, wherein the at least two cores form a core assembly, wherein each core of the core assembly is coded differently from one another.

4. The method according to claim 3, further comprising:
coding at least two cores, wherein the coding is provided in such a way that adjacent cores of a respective core pair or core assembly are coded differently.

5. The method according to claim 1, comprising the following method step:
carrying out electrical testing during the acceptance test and/or pre-test, wherein it is tested that a plug end of a core is only electrically connected to the respective associated connection end of the same core.

6. The method according to claim 1, further comprising:
carrying out at least one of the actions pre-test action or final test action, wherein transmitting at least one data set to the piece of data processing equipment and/or a database connection is included and/or the documentation of the final test result and/or the pre-test result is included.

7. The method according to claim 1, further comprising:
transmitting the test result to the data processing device, wherein the data processing device is formed in the cloud.

8. A method for error-minimized electrolysis stack contacting, comprising:
providing an assembly device, wherein the assembly device comprises at least one mount for at least two cores, wherein each core has a plug end and a connection end;
providing a control device, wherein the control device comprises at least one first device for automatic detection and a second device for electrical testing;
providing a contacting unit, wherein the contacting unit comprises at least one plug-in unit, wherein the plug-in unit is electrically connectable to the at least two plug ends of the at least two cores;
providing at least one coding on the at least one plug-in unit and/or the respective plug end and/or the respective connection end and/or on the respective core of the at least two cores;
carrying out a first electrical pre-test by the control device, wherein an electrical continuity from a plug end to the associated connection end of the at least two cores is tested;
carrying out a pre-test for an automatic pre-test, wherein the position of the connection ends within the assembly device is controlled on the basis of the coding;
evaluating the result of the optical pre-test and the electrical pre-test by at least one evaluation unit which is designed to carry out the pre-test action and/or an acceptance test action;
transmitting the pre-test result of the automatic and/or the electrical pre-test to a piece of data processing equipment and carrying out a predetermined pre-test action.

9. The method according to claim 8, further comprising:
providing at least one plug-in board for electrical testing, wherein the plug-in board comprises at least two connections for plugging in the connection ends.

10. A device for error-minimized stack contacting, comprising:
an assembly device, wherein the assembly device comprises a mount for at least two cores;
a control device, wherein the control device comprises at least one first device for automatic detection and/or one second device for electrical testing;
at least one contacting unit, wherein the contacting unit comprises at least one plug-in unit, wherein the plug-in unit is electrically connectable to at least two plug ends of the at least two cores;
at least one evaluation unit which is designed to carry out the pre-test action and/or acceptance test action;
a piece of data processing equipment and/or a database connection;
a piece of communication equipment which is designed to establish communication with the piece of data processing equipment and/or the database connection, wherein the database connection is designed as a wired data connection and/or as a wireless data connection.

11. The device according to claim 10, wherein the piece of data processing equipment is part of the control device or is arranged spaced apart from the device and/or the control device is connected to a master computer.
